(19) United States
(12) Patent Application Publication
(10) Pub. No.: US 2005/0110465 A1
(43) Pub. Date: May 26, 2005

(54) Cellular telephone charging circuit using dry battery

(75) Inventor: Isamu Tanishita, Shizuoka (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: TOPLAND CORPORATION, Shizuoka (JP)

(21) Appl. No.: 11/010,405

(22) Filed: Dec. 14, 2004

(30) Foreign Application Priority Data
Sep. 11, 2003 (JP) 2003-319740

(51) Int. Cl. H02J 7/00

(52) U.S. Cl. 320/141

(57) ABSTRACT

A cellular telephone charging circuit using a dry battery and capable of displaying a charging operation by a light-emitting diode (LED) when the charging operation is actually carried out is provided. The cellular telephone charging circuit using the dry battery as a power supply and including a boost switching regulator that supplies a predetermined charging power to a charging terminal of a cellular telephone, includes: the LED for displaying the charging operation; a control circuit that generates an ON and OFF control signal for driving a boost chopper included in the boost switching regulator; a chopper ON-period detection circuit that detects an ON-period of the boost chopper; and an LED lighting circuit that drives the LED when the ON-period detected by the chopper ON-period detection circuit reaches a predetermined value.

### BACKGROUND OF THE INVENTION

1. Field of the Invention

The present invention relates to a cellular telephone charging circuit for charging (normally quickly charging) a battery built in the cellular telephone by using a dry battery. More specifically, the present invention relate to a cellular telephone charging circuit capable of displaying a charging operation using a light-emitting diode (LED) only when a battery built in the cellular telephone is actually charged.

2. Description of the Related Art

Many conventional cellular telephone charging circuits using dry batteries are not provided with means (LED's) for displaying respective charging operations. Some cellular telephone chargers include LED's for displaying respective charging operations and fully charged states.

FIG. 6 is a block diagram that depicts an example of a conventional cellular telephone charger 5 using a dry battery and including an LED for displaying a charging operation. In the charger 5 shown in FIG. 6, a dry battery BC (at a power supply voltage E) is connected to input terminals a1 and a2 of a power supply circuit (DC/DC converter) 51. A charging current-limiting resistor R1 is connected between the power supply circuit 51 and one output terminal b1. A display circuit constituted by an LED current-limiting resistor R2 and an LED D1 is connected between output terminals b1 and b2. A cellular telephone built-in battery 52 is connected to the output terminals b1 and b2 and the LED D1 is turned on during a charging operation.

FIG. 7 is a block diagram that depicts an example of a cellular telephone charger 6 that charges a battery built in a cellular telephone and that includes an LED for displaying a charging operation. In the charger 6 shown in FIG. 7, a commercial AC power supply is connected to input terminals a1 and a2 of a power supply circuit (an AC/DC inverter) 61. A charging current-limiting resistor R1 is connected between the power supply circuit 61 and one output terminal b1. A comparison circuit 63 constituted by a comparator CMP, input-side resistors R3, R4, R5, and R6, and a feedback resistor R7 is connected in rear of the power supply circuit 61. A display circuit constituted by an LED current-limiting resistor R2 and an LED D1 is connected between one terminal of the power supply circuit 61, which terminal is connected to the charging current-limiting resistor R1 and an output terminal of the comparator CMP. A cellular telephone built-in battery 62 is connected to output terminals b1 and b2 and the LED D1 is turned on during a charging operation.

In the charger 5 shown in FIG. 6, when the power supply circuit 51 is driven, a power is supplied to the cellular telephone built-in battery 52 and the LED D1 is turned on by a charging voltage between the output terminals b1 and b2. Due to this, the LED D1 is turned on whenever the power supply circuit 51 is driven irrespectively of whether the cellular telephone built-in battery 52 is charged. A user, therefore, determines that the charging operation is carried out even in a non-chargeable state.

Specifically, the LED D1 is turned on even if (1) the cellular telephone built-in battery 52 rejects being charged, (2) the cellular telephone built-in battery 52 is fully charged, or (3) a capacity of the battery cell BC of the charger 5 is reduced, the battery cell BC is incapable of charging the battery, but the battery cell BC outputs a voltage sufficient to turn on the LED D1.

An ordinary LED is turned on whenever a voltage equal to or higher than a forward voltage Vf is applied between an anode and a cathode. The forward voltage Vf for the LED depends on an emission color, a current, a manufacturing method, an emission material, or the like, and the forward voltage Vf for an ordinary red LED is about 1.5 to 2.0 volts (V). The LED is, therefore, driven even if the capacity of the dry cell of the charger 5 is reduced (case (3) stated above).

In the charger 6 shown in FIG. 7, the LED can be turned on when a current equal to or higher than a certain current is carried to the cellular telephone built-in battery 62.

Namely, in the charger 6, if a voltage difference Vd of the charging current-limiting resistor R1 is detected and the voltage difference Vd is equal to or higher than a certain value (R1×i=Vd, where symbol i denotes a charging current), then the comparator CMP is actuated, a current is applied to the LED D1, and the LED D1 is thereby turned on.

This conventional charger 6 has, however, many components and each component is expensive. Due to this, although the charger 6 can be used as a charger for charging a cellular telephone built-in battery, it cannot be used as a cellular telephone charger using a dry battery and sold at a low price.

### SUMMARY OF THE INVENTION

It is an object of the present invention to provide a cellular telephone charging circuit using a dry battery and capable of displaying a charging operation only when the charging operation is actually carried out, with a simple circuit configuration.

According to the present invention, there is provided a cellular telephone charging circuit using a dry battery as a power supply and including a boost switching regulator that supplies a predetermined charging power to a charging terminal of a cellular telephone, comprising: a light-emitting diode for displaying a charging operation; a control circuit that generates an ON and OFF control signal for driving a boost chopper included in the boost switching regulator; a chopper ON-period detection circuit that detects an ON-period of the boost chopper; and a light-emitting diode lighting circuit that drives the light-emitting device when the ON-period detected by the chopper ON-period detection circuit reaches a predetermined value.

The cellular telephone charging circuit using the dry battery according to the present invention is mainly applied to a cellular telephone quick charger.

The cellular telephone charging circuit using the dry battery according to the present invention can be constitute so that the chopper ON-period detection circuit is a CR integrating circuit that inputs the ON and OFF control signal, and so that the light-emitting diode lighting circuit drives the light-emitting diode when a voltage of the CR integrating circuit reaches a predetermined voltage. In this case, the light-emitting diode lighting circuit includes a resistor and a transistor switch between a positive terminal and a negative terminal of the battery, the light-emitting device is connected between the transistor switch and a ground, and the voltage output from the CR integrating circuit is input to a control terminal of the transistor switch.

The present invention can provide the cellular telephone charging circuit using the dry battery, and capable of displaying a charging operation only when the charging operation is actually carried out, with a simple circuit configuration, or low production cost.

### BRIEF DESCRIPTION OF THE DRAWINGS

FIG. 1 is a functional block diagram of a cellular telephone charging circuit using a dry battery according to the present invention;

FIG. 2 is a specific circuit diagram of the cellular telephone charging circuit using the dry battery shown in FIG. 1;

FIG. 3 is a circuit diagram that depicts a chopper ON-period detection circuit, an LED lighting circuit, and an LED extracted from the circuit shown in FIG. 2;

FIG. 4 is a time chart that depicts a control signal, a terminal voltage of a capacitor, and transistor ON and OFF states in the circuit shown in FIGS. 2 and 3;

FIG. 5 is a front view of a cellular telephone charger mounting therein the cellular telephone charging circuit using the dry battery according to the present invention;

FIG. 6 is a block diagram that depicts one example of a conventional cellular telephone charger using a dry battery and including an LED for displaying a charging operation; and

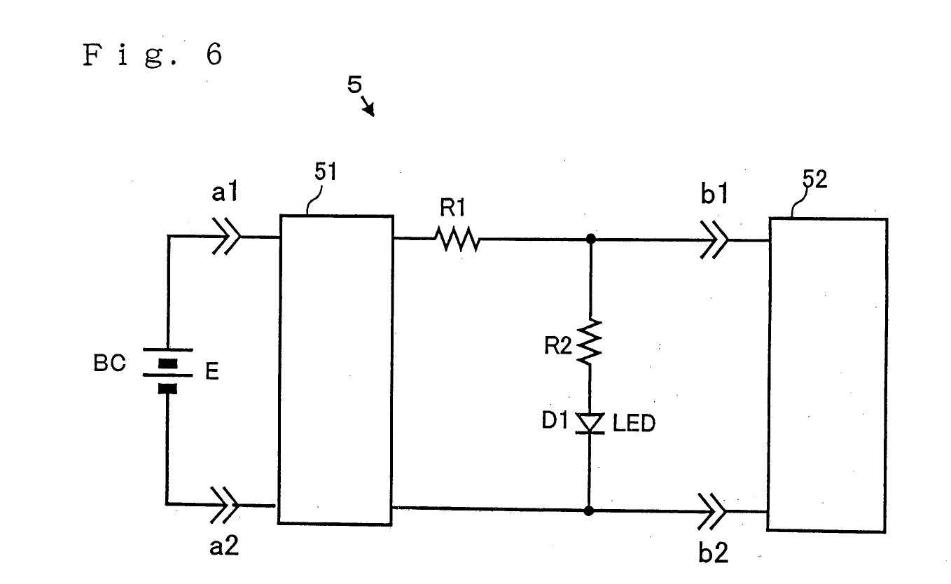

FIG. 7 is a block diagram that depicts one example of a conventional cellular telephone built-in battery charger and including an LED for displaying a charging operation.

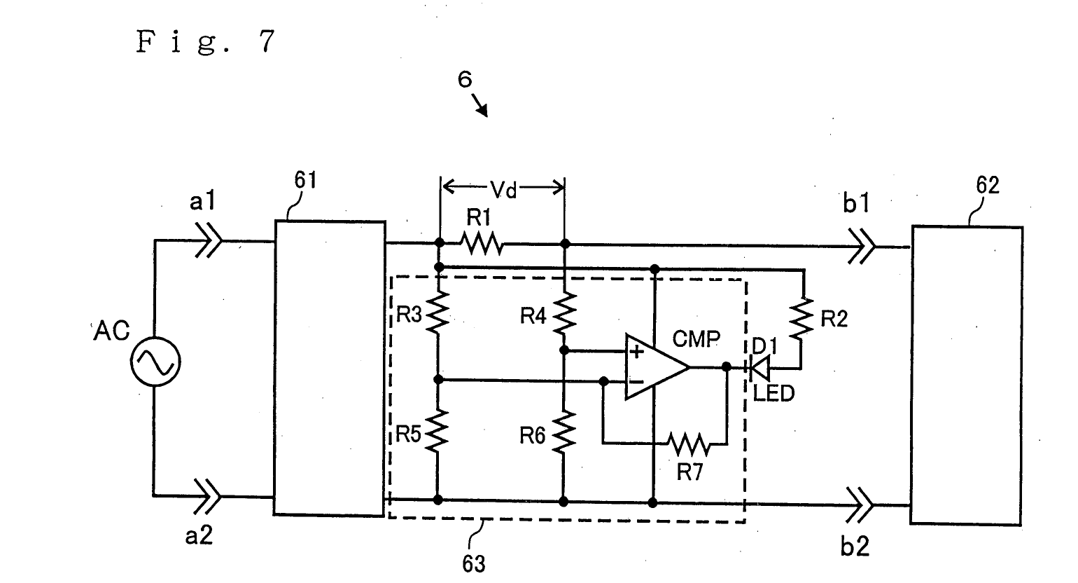

### DETAILED DESCRIPTION OF THE PREFERRED EMBODIMENT

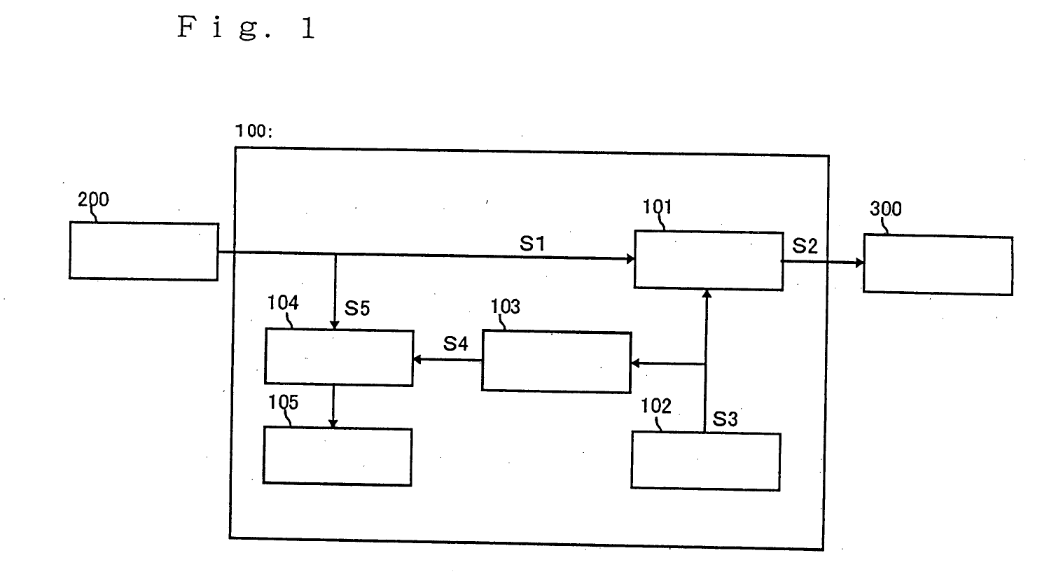

FIG. 1 is a functional block diagram of a cellular telephone charging circuit 100 using a dry battery according to the present invention. In FIG. 1, the cellular telephone charging circuit 100 using a dry battery includes a boost chopper 101, a control circuit 102, a chopper ON-period detection circuit 103, an LED lighting circuit 104, and a charging operation display LED 105. The boost chopper 101 is constituted by an inductor and a transistor switch, as will be described later.

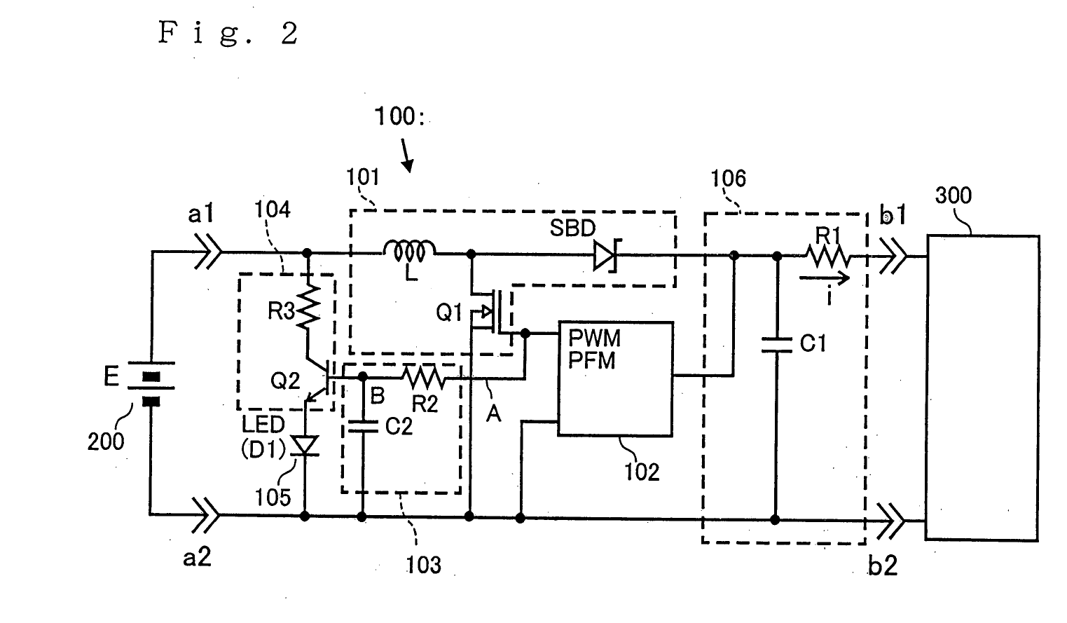

In an actual charging circuit, the boost chopper 101 and an output circuit 106 constitute a boost switching regulator as shown in FIG. 2.

The control circuit 102 can generate an on and off control signal, e.g., a pulse width modulation (PWM) control signal or a pulse frequency modulation (PFM) control signal, for driving the boost chopper 101. The chopper ON-period detection circuit 103 can detect an ON period of the boost chopper 101. The LED lighting circuit 104 can drive the LED 105 when the ON period detected by the chopper ON-period detection circuit 103 reaches a predetermined value. The LED 105 is, for example, red light-emitting diode (red LED).

In the cellular telephone charging circuit 100 using the dry battery 200 shown in FIG. 1, when a power SI is supplied (from the dry battery 200), the control circuit 102 controls the boost chopper 101 by a predetermined signal S3. Under control of the control circuit 102, the power S1 from the dry battery 200 is supplied to the boost chopper 101, and the boost chopper 101 charges a cellular telephone built-in battery 300 at a predetermined charging voltage and a predetermined charging current denoted by reference symbol S2.

The control signal S3 from the control circuit 102 is also input to the chopper ON-period detection circuit 103, and the copper ON-period detection circuit 103 can thereby detect an ON period of the boost chopper 101. Specifically, the chopper ON-period detection circuit 103 can be constituted by a CR integrating circuit, as will be described later. If the chopper ON-period detection circuit 103 is the CR integrating circuit, for example, the LED lighting circuit 104 turns on the LED 105 when an output voltage (a charging voltage of a capacitor constituting the CR integrating circuit) reaches a predetermined voltage (in response to a detection signal S4 transmitted from the LED lighting circuit 104). In addition, the LED 105 is turned on by a power S5 from the dry battery 200.

A lithium-ion battery is normally used as the cellular telephone built-in battery 300. A rated output voltage of the lithium-ion battery is normally about 3.6 to 3.7 V. It is necessary to charge the lithium-ion battery at a voltage equal to or higher than the rated output voltage and a current equal to or higher than 80 milliamperes (mA). Normally, the lithium-ion battery is charged at a voltage equal to or higher than 4.5 V and lower than 5.7 V and a current of 300 to 600 mA.

FIG. 2 is a specific circuit diagram of the cellular telephone charging circuit 100 using the dry battery 200 shown in FIG. 1. In the cellular telephone charging circuit 100 using the dry battery 200 shown in FIG. 2, the dry battery 200 is connected to input terminals a1 and a2. It is assumed herein that the dry battery 200 is two battery cells each at a voltage of 1.5 V, connected in series, and having a voltage of 3 V in all.

The boost chopper 101 is constituted by an inductor L, a transistor switch (a field effect transistor (FET) in this embodiment) Q1, and a diode (a Schottky barrier diode) SBD. The control circuit 102 is constituted by an integrated circuit (IC) capable of outputting the PWM or PFM control signal to an output terminal of the transistor switch Q1.

The chopper ON-period detection circuit 103 is constituted by an integrating circuit composed by a resistor R2 and a capacitor C2. The LED lighting circuit 104 is constituted by an LED current-limiting resistor R3 and a transistor switch (a bipolar transistor in this embodiment) Q2. The LED 105 is a red LED.

FIG. 2 also shows that the output circuit 106 composed by an output current-limiting resistor R1 and a smoothing capacitor C1 is connected to an output stage (between the output terminals b1 and b2) of the cellular telephone charging circuit 100 using the dry battery 200.

In FIG. 2, the boost chopper 101 and the output circuit 106 constitute the boost switching regulator.

In the cellular telephone charging circuit 100 using the dry battery 200 shown in FIG. 2, when the transistor switch Q1 is turned on, energy is accumulated in the inductor L. When the transistor switch Q1 is turned off, the energy accumulated in the inductor L is supplied to the output circuit 106 through the Schottky barrier diode SBD and a charging current i is supplied to the cellular telephone built-in battery 300.

Therefore, if the ON period of the transistor switch Q1 (a period for energizing the inductor L) is longer, the energy accumulated in the inductor L is higher and the charging current i is higher.

In this embodiment, if the charging current i exceeds a predetermined value, the ON period of the transistor switch Q1 is equal to or longer than a certain time and the LED 105 is turned on, accordingly.

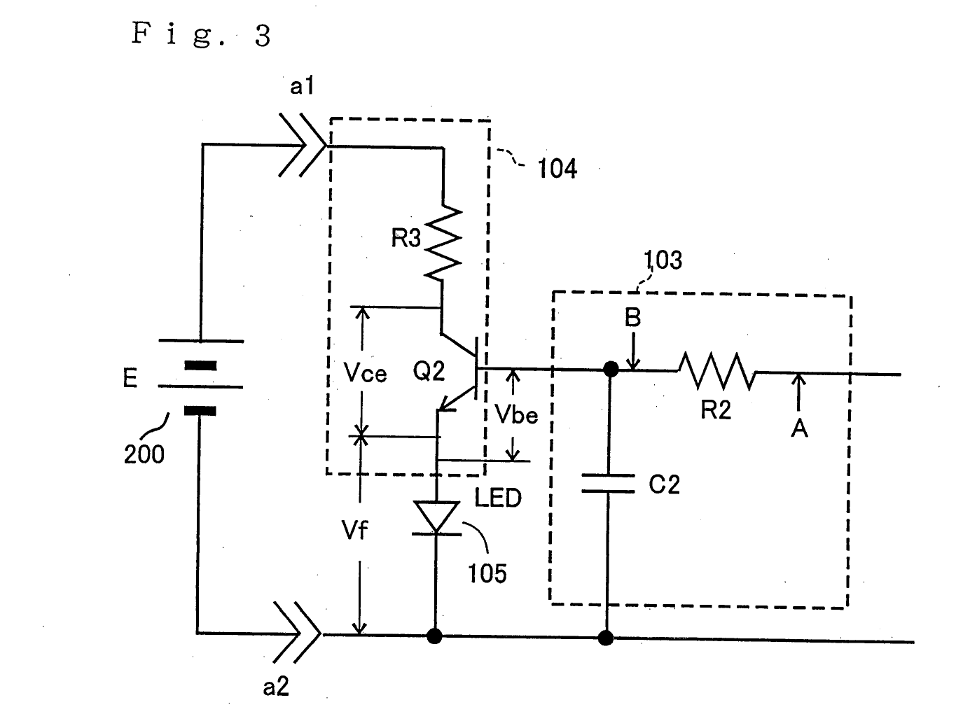

FIG. 3 is a circuit diagram that depicts the chopper ON-period detection circuit 103, the LED lighting circuit 104, and the LED 105 extracted from the circuit shown in FIG. 2. Referring to FIG. 3, a control signal CTRL (appearing at a point A) of the transistor switch Q1 is integrated by the chopper ON-period (integrating circuit) 103 composed by the resistor R2 and the capacitor C2. When a voltage at a point B (a voltage of the capacitor C2) reaches a predetermined voltage Vsh (=Vbe+Vf), the transistor switch Q2 is turned on to carry a current to the LED 105, thereby turning on the LED 105.

The voltage Vbe is an emitter-base voltage of the transistor switch Q2, and the voltage Vf is a forward voltage of the LED 105.

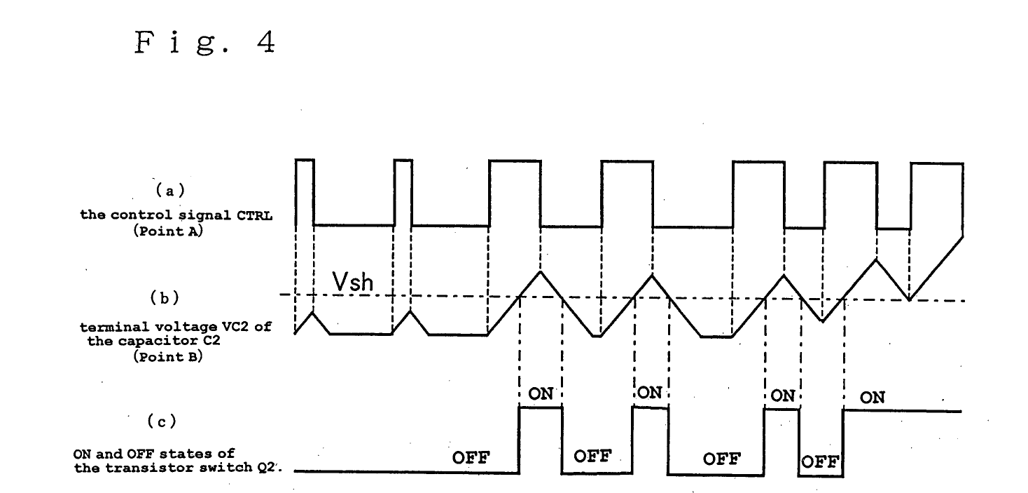

FIG. 4 is a time chart that depicts the control signal CTRL, a terminal voltage VC2 of the capacitor C2, and ON and OFF states of the transistor switch Q2.

In this embodiment, the LED 105 is connected to an emitter side of the transistor switch Q2. It is thereby possible to increase the predetermined voltage, i.e., threshold voltage Vsh, at which the transistor switch Q2 is turned on, by as much as the forward voltage Vf (e.g., about 1.7 V).

Further, when a waveform at the point A is at an L level, charges accumulated in the capacitor C2 can be promptly emitted (that is, a difference between the Vsh and an L-level potential can be set large). It is thereby possible to ensure turning off the LED 105 when an H-level time of the waveform at the point A is short and the charging current i is not carried to the cellular telephone built-in battery 300.

When the dry battery 200 is consumed and the battery voltage E is lower, the H-level time at the point A is longer even at the equal charging current i. In this embodiment, the LED 105 is connected to the emitter of the transistor switch Q2 and directly driven by the battery voltage E.

Therefore, to turn on the LED 105, the following condition needs to be satisfied.
Vf<E−Vcc−If×R3, that is,

E>Vf+Vce−If×R3, where symbol Vce denotes an emitter-collector voltage of the transistor switch Q2 and If denotes the current carried to the LED 105.

If it is assumed that Vf is 1.7 V, Vce is 0.2 V, and If×R3 is 0.1 V, the condition is represented by:
E>1.7+0.2+0.1=2.0 [V]

According to this embodiment, therefore, the LED 105 is turned of f in a battery consumed state (the battery voltage lower than 2.0 V).

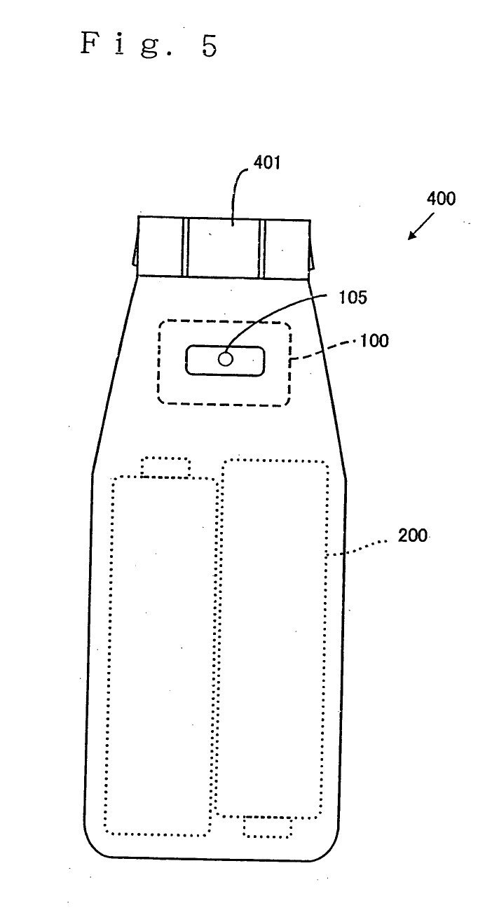

FIG. 5 is a front view of a cellular telephone charger 400 mounting therein the cellular telephone charging circuit 100 using the dry battery 200. In the cellular telephone charger 400 mounting therein the cellular telephone charging circuit 100 using the dry battery 200 shown in FIG. 5, when a terminal portion 401 (corresponding to the output terminals b1 and b2) is connected to a charging terminal of a cellular telephone (not shown), the charging current is carried from the dry battery 200. In addition, the LED 105 is turned on only when an appropriate charging operation is carried out.

1. A cellular telephone charging circuit using a dry battery as a power supply and including a boost switching regulator that supplies a predetermined charging power to a charging terminal of a cellular telephone, comprising:
a light-emitting diode for displaying a charging operation;
a control circuit that generates an ON and OFF control signal for driving a boost chopper included in said boost switching regulator;
a chopper ON-period detection circuit that detects an ON-period of said boost chopper; and
a light-emitting diode lighting circuit that drives said light-emitting device when the ON-period detected by said chopper ON-period detection circuit reaches a predetermined value.

2. The cellular telephone charging circuit using the dry battery according to claim 1, wherein
said chopper ON-period detection circuit is a CR integrating circuit that inputs said ON and OFF control signal, and
said light-emitting diode lighting circuit drives said light-emitting diode when a voltage of said CR integrating circuit reaches a predetermined voltage.

3. The cellular telephone charging circuit using the dry battery according to claim 2, wherein
said light-emitting diode lighting circuit includes a resistor and a transistor switch between a positive terminal and a negative terminal of said dry battery,
said light-emitting device is connected between said transistor switch and a ground, and
the voltage output from said CR integrating circuit is input to a control terminal of said transistor switch.
